(19) United States
(12) Patent Application Publication
(10) Pub. No.: US 2005/0257888 A1
(43) Pub. Date: Nov. 24, 2005

(54) Phenolic resin-based adhesives and methods of using same in preparing laminated veneer lumber (LVL)

(75) Inventors: Bobby L. Williamson, Conyers, GA (US); Millard E. Foucht, Stone Mountain, GA (US); Jean-Pascal Theberge, Covington, GA (US); Barry W. Sewell, Covington, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 10/849,570

(22) Filed: May 20, 2004

(51) Int. Cl. B32B 31/00

(52) U.S. Cl. 156/331.1; 156/336

(57) ABSTRACT

Adhesive compositions and methods of using the compositions in the production of laminated veneer lumber (LVL) are disclosed. The adhesive compositions comprise a thermosetting phenol-aldehyde resin having at least one of (A) a number average molecular weight (Mₙ) of at least about 450, (B) a weight average molecular weight (M_{w}) of at least about 2000, and (C) a Z-average molecular weight (M_{z}) of at least about 6000, wherein said Mₙ, M_{w}, and M_{z} are measured using gel permeation chromatography (GPC), a ketone-aldehyde resin cure promoter, and optionally other components (e.g., a tack-promoter or a catalyst). The adhesive compositions minimize or eliminate the art-recognized problems of glue line dryout and steam blowout, associated with LVL manufacture from both low-moisture veneers and high-moisture veneers, respectively. Furthermore, the adhesive compositions provide fast tack-build and curing as well as ultimately good bonding characteristics.

### FIELD OF THE INVENTION

The present invention relates to an adhesive composition and its use in making laminated veneer lumber (LVL) from a plurality of wood veneers. The adhesive composition comprises a thermosetting phenol-aldehyde resin, a ketone-aldehyde (e.g., acetone-formaldehyde) resin cure promoter, and optionally other components (e.g., a tack-promoter and/or a catalyst). The thermosetting phenol-aldehyde resin has molecular weight characteristics suitable for providing a quick cure and an excellent adhesive bond in the manufacture of laminated veneer lumber (LVL) over a wide-range of moisture levels and/or thicknesses.

### BACKGROUND OF THE INVENTION

Due to their bonding and durability characteristics, phenol-aldehyde resins, particularly phenol-formaldehyde resins, have long been favored as adhesives for preparing laminated veneer lumber (LVL) and other wood laminates (e.g., plywoods) suitable for exterior use. Typically, these adhesives are applied to the mating surfaces of wood veneers and the veneers then are formed into LVL by subjecting them to one or more pressing operations to (i) consolidate them into a unitary panel and (ii) cure the adhesive. Often, the pressing is performed in two stages to separately address the above objectives (i) and (ii) and maximize output. Two-stage pressing normally includes a first stage of pre-pressing at ambient or somewhat elevated temperature and under a pressure and for a time sufficient to consolidate the veneers into a unitary panel or billet, such that the veneers will resist failure due to shearing or collapse under further processing conditions (e.g., transfer from the pre-pressing stage to a hot-pressing or curing stage). Thus, the consolidated panel after pre-pressing can be stored and handled without shifting or separation of the veneers prior to hot-pressing (i.e., treatment under heat and pressure to cure the thermosetting adhesive) to form the final laminate. Depending on the thickness of the panel and other factors, the time needed for hot-pressing the veneers to effect curing of the adhesive can vary widely from roughly 1 minute to 1 hour or even longer.

The use of high moisture (e.g., 10-15% water by weight) veneers in conventional LVL manufacturing processes is desirable for several reasons. One advantage is the reduction in raw materials costs associated with the ability of veneer suppliers to decrease drier energy requirements and/or increase their throughput by reducing drier residence time. Also, the overall quantity of drier emissions is reduced, easing environmental concerns. Finally, the ability to prepare laminates using high moisture content veneers relaxes the criticality of moisture control during preparation. In addition to these capital cost savings resulting from less restrictive drying requirements, the use of higher moisture veneers also leads to improvements in the dimensional stability of the ultimate consolidated wood laminates. In particular, conventional laminates made with veneers having less than about 5% moisture content tend to swell in size as the moisture content of the wood gradually increases to its equilibrium value over time. In humid summer months, the equilibrium moisture content of a wood laminate may be as high as 10% by weight.

Despite these apparent advantages, high moisture veneers are unfortunately also well known to promote lamination defects and, correspondingly, an excessively large number of rejected panels because of poor lamination. These lamination defects are believed to result from steam formation between veneer layers and the subsequent release of the formed steam when pressure is released upon completion of the hot-pressing or curing operation. Steam may escape either through the adhesive layer, causing edge delamination, or through the veneer itself, resulting in steam pressure blows. Either type of steam release (i.e., a blowout or pressure blow) may severely compromise the ultimate panel integrity.

The prior art has recognized these problems and consequently the advantages with respect to both capital and operating costs if higher moisture content veneers could be employed in the preparation of wood laminates. In U.S. Pat. No. 4,239,577, for example, a process is described for preparing wood laminates from high moisture content wood veneers. In accordance with this process, panels are prepared using veneers having different moisture contents with higher moisture content veneers constituting the outer layers of the panel and lower moisture content veneers constituting the core. While this process purports to ameliorate problems encountered when using high moisture content veneers, it does not eliminate the need for drying at least some of the veneers to low moisture content.

In U.S. Pat. No. 4,441,945, an adhesive is described which purportedly permits the preparation of wood laminates using high moisture content veneers. The adhesive composition combines phenol-aldehyde resin, an alkaline catalyst and from 5-50%, based on the weight of resin solids, of bentonite clay. The adhesive also may contain other conventional additives such as fillers and extenders. Apparently, this adhesive has not received widespread acceptance in the industry, which continues to search for ways to reduce substantially the need to dry high moisture content veneers before assembling them into unitary wood laminates.

In U.S. Pat. No. 5,234,747, steam generated in the hot-pressing stage and caused by veneer moisture is permitted to escape the veneer layers by incising the veneer sheets in the green stage prior to drying. However, mechanical “outlets” for steam add an element of complexity to the veneer preparation and, to some extent, affect the ultimate strength of the LVL product.

U.S. Pat. No. 4,915,766 describes an adhesive for use bonding high moisture veneers, wherein the adhesive a phenol-aldehyde resin and a low molecular weight acetone-formaldehyde cure rate accelerator. The '766 patent is silent with regard to the degree of advancement of the phenol-aldehyde resin.

Because the art has not satisfactorily addressed these difficulties associated with high moisture veneers, it remains the convention in the wood laminate industry to dry the wood veneers to very low moisture content, (e.g., about 3-7% moisture by weight), before application of the adhesive and formation of LVL. However, a well-documented problem associated with the use of dry veneers is the potential for dryout of the glue line in the manufacturing process, leading to weak bonding of the adhesive and ultimately delamination. For example, Sellers, Jr. states, “It is estimated that over 95% of the deficient bonds in southern pine plywood produced in 1980 involved a form of dryout. Dry veneer below 3% moisture content can result in severely dried-out gluelines”. (PLYWOOD AND ADHESIVE TECHNOLOGY, Marcel Dekker, Inc., p. 423). Furthermore, when phenol-formaldehyde resin adhesives are used, this dryout problem is believed to be exacerbated by the use of resins having a high molecular weight. (see Gollob, L., “The Interaction of Formulation Parameters with Chemical Structure and Adhesive Performance of Phenol-Formaldehyde Resins”, Doctoral Thesis submitted to Oregon State University, 1982). The current practice is therefore to limit resin molecular weight by using relatively mild preparation or “cooking” conditions, with typical phenol-formaldehyde thermosetting resins, for example, having a number average molecular weight (Mₙ), a weight average molecular weight (M_{w}), and a Z-average molecular weight (M_{z}), of not more than 400, 1500, and 3000 grams/mole, respectively, as measured by gel permeation chromatography (GPC). Limitations on the resin molecular weight or advancement, however, have the practical disadvantages of longer curing times and/or greater difficulty of developing tackiness, in the pre-pressing stage, that is required to maintain panel integrity upon transfer to the hot-pressing or curing stage. These qualities lead to longer processing cycles (i.e., reduced throughput) and/or an increased incidence of pre-pressed panel collapse.

For these reasons, there remains a need in the art to develop thermosetting phenol-aldehyde adhesive compositions for use in LVL preparation that (i) quickly develop tack and rapidly cure in LVL formation from wood veneers having low moisture content, without significant dryout of manufacturing glue lines, and/or (ii) reduce or eliminate the frequency of panel failure due to steam blowout from veneers having high moisture content. These properties are preferably realized in adhesive compositions that, relative to known compositions, provide comparable or better bonding strength of wood veneers.

### SUMMARY OF THE INVENTION

The present invention provides adhesive compositions and methods of using the compositions in the production of LVL. The adhesive compositions minimize or eliminate the art-recognized problems of glue line dryout and steam blowout, associated with LVL manufacture from both low-moisture veneers and high-moisture veneers, respectively. In the case of low-moisture and/or warm temperature veneers, although the phenol-aldehyde resins used in the adhesive compositions of the present invention are higher in molecular weight (i.e., more advanced in polymerization degree) than conventional phenol-aldehyde resins, these adhesives are surprisingly resistant to glue line dryout. Furthermore, the adhesive compositions provide fast tack-build and curing as well as ultimately good bonding characteristics.

Without being bound by theory, it is believed that the addition of a ketone-aldehyde (e.g., an acetone-aldehyde or a ketone-formaldehyde, such as acetone-formaldehyde) cure promoter alone or in combination with other accelerants (e.g., a catalyst such as triacetin) and/or agents (e.g., a tack-promoter such as a soya compound), can provide buffering and thereby improve adhesive penetration into veneer substrates to prevent dryout. For example, it has been demonstrated that adhesive compositions of the present invention can allow newly assembled billets, if necessary, to have a stand time in excess of 45 minutes before pre-pressing, which for a conventional fast-curing adhesive applied in hot weather will present dryout problems. In other cases, the speed of cure and speed of tack build afforded by adhesive compositions of the present invention will allow for the practical advantage of being exposed to dryout conditions for only 2 to 3 minutes before being pre-pressed.

The compositions comprise a phenol-aldehyde thermosetting resin having a molecular weight distribution, as indicated by at least one of its number average molecular weight (Mₙ), its weight average molecular weight (M_{w}), or its Z-average molecular weight (M_{z}), that is characteristic of advanced resins. The adhesive compositions further comprise a ketone-aldehyde resin cure promoter and optionally other components, depending on the specific use. For example, in high moisture veneer service, the addition of a catalyst (e.g., triacetin) has been found beneficial. Alternatively, the addition of a soya compound advantageously provides needed tackiness for the consolidation of LVL in certain ranges of thickness (e.g, comprising from 13 to 29 wood veneers).

Accordingly, in a first embodiment the present invention is an adhesive composition comprising a thermosetting phenol-aldehyde resin having at least one of (A) a number average molecular weight (Mₙ) of at least about 450, (B) a weight average molecular weight (M_{w}) of at least about 2000, and (C) an Z-average molecular weight (M_{z}) of at least about 6000. The composition further comprises a ketone-aldehyde resin cure promoter.

In a second embodiment, the present invention is an adhesive composition according to the first embodiment and further comprising a soya compound having a protein level of at least about 50% by weight. Preferably, the composition, with the added soya compound, reaches a viscosity of 3000 centipoise at a temperature of 77° F. (25° C.) in a time of less than about 20 minutes after initial mixing.

In a third embodiment, the present invention is an adhesive composition according to the first embodiment and further comprising a catalyst selected from the group consisting of a carbamate (e.g., an alkyl carbamate such as ethyl carbamate), an ester (e.g., a saturated ester such as triacetin, an acrylic ester such as methyl methacrylate, or a vinyl ester such as vinyl acetate), a lactone (e.g., ε-caprolactone, γ-caprolactone, β-butyrolactone, β-propiolactone, γ-butyrolactone, α-methyl-γ-butyrolactone, β-methyl-γ-butyrolactone, γ-valerolactone, δ-valerolactone, γ-nonanoic lactone, γ-octanoic lactone, or pentolactone), a carbonate (e.g., calcium carbonate), and a compound having activated methylol groups (e.g., trimethylolnitromethane). Preferably, the catalyst is triacetin, a triacetate compound.

In another embodiment, the present invention is a method for making LVL from a plurality of wood veneers. The method comprises applying the adhesive according to any of the above embodiments to a mating surface of at least one of the wood veneers and forming LVL from the wood veneers. In a preferred embodiment, forming LVL comprises (i) pre-pressing the wood veneers, having the surface or surfaces to which the adhesive has been applied, under pre-pressing conditions to form a panel, and (ii) hot-pressing the panel at curing conditions to cure the adhesive. In another preferred embodiment, at least one of the veneers has a moisture content of less than about 7% by weight or the plurality of wood veneers has an average moisture content of less than about 10% by weight. In another preferred embodiment, the method comprises applying an adhesive composition according to any of the first, second, or third embodiments, and preferably an adhesive composition according to the second embodiment, to a mating surface of at least one of the wood veneers, wherein the LVL comprises from 13 to 29 wood veneers. In another preferred embodiment, the method comprises applying an adhesive according to any of the first, second, or third embodiments, and preferably an adhesive according to the third embodiment, to a mating surface of at least one of the wood veneers and at least one of the veneers has a moisture content of greater than about 15% by weight or the plurality of wood veneers has an average moisture content of greater than about 10% by weight.

These and other embodiments are apparent from the following Detailed description.

### BRIEF DESCRIPTION OF THE DRAWING

FIG. 1 graphically illustrates the tack-build characteristics of adhesives of the present invention, based on the viscosities that are reached over time.

### DETAILED DESCRIPTION OF THE INVENTION

As used herein, the number average molecular weight (Mₙ), the weight average molecular weight (M_{w}), and the Z-average molecular weight (M_{z}) of a polymer are calculated as follows:

$${M}_{n} = \frac{{\sum }_{i} {N}_{i} {M}_{i}}{{\sum }_{i} {N}_{i}} , {M}_{w} = \frac{{\sum }_{i} {N}_{i} {M}_{i}^{2}}{{\sum }_{i} {N}_{i} {M}_{i}} , and {M}_{z} = \frac{{\sum }_{i} {N}_{i} {M}_{i}^{3}}{{\sum }_{i} {N}_{i} {M}_{i}^{2}} .$$

wherein Nᵢ is the number of polymer species having i repeat units and Mᵢ is the molecular weight of the polymer species having i repeat units.

These definitions are well known in the art for characterizing polymer samples having a distribution of molecular weights. A more thorough discussion of the significance of Mₙ, M_{w}, and M_{z} is found, for example, in Rempp and Merrill. [POLYMER SYNTHESIS, Huthig & Wepf (1986), p. 24-28]. As used herein, the values Mₙ, M_{w}, and M_{z} can be determined using gel permeation chromatography (GPC) analysis, using a dimethyl formamide (DMF) solvent, polystyrene standards and procedures well known to those skilled in the art. In this experiment, a calibration curve is developed using polystyrene which has been adjusted by a factor of M_{w}/40 to approximate historical values for the number average molecular weight (Mₙ), obtained by NMR. The standards and stationary phase materials (i.e., columns) may be obtained from Polymer Laboratories, Inc. (Amherst, Mass. USA). In characterizing polymer molecular weight, Rempp and Merrill explain, “It has become virtually essential to submit the polymer to size exclusion chromatography, SEC, also called gel permeation chromatography, GPC, which, upon calibration, can display an image of the actual molecular weight distribution on a diagram.” The quantities Mₙ, M_{w}, and M_{z} are all expressed in terms of grams/mole (g/mol).

As used herein, “veneer” refers to thin sheets of wood produced, for example, by skiving a thin wood layer or sheet from a log. Commonly, a veneer strip is unwound in a long, continuous ribbon at a preset thickness from a log mounted on a veneer lathe. Generally, a veneer will have a thickness of about 0.125 inches (3.2 mm), but can range from about 0.0315 inches (0.80 mm) to about 1.77 inches (45 mm). Veneers may be provided for laminated veneer lumber (LVL) manufacture, for example, as continuous sheets that are laid up and consolidated. Various widths of these sheets are possible, with a 4-foot width being representative.

As used herein, “veneer moisture content” refers to the ratio, expressed as a percentage, between the weight of the water in the wood veneer (i.e., the “as is” weight minus the dry weight) and the dry weight of the wood veneer itself. The measured moisture content of a veneer layer may be based on a “spot” analysis, such as commonly performed using a hand-held moisture analyzer with probes for determining electrical conductivity. Alternatively, the measured moisture content of a veneer layer may be the average value, for example using NIR, microwave radiation, or other known techniques, of several periodic measurements or a continuous measurement over some or all of the surface of the veneer. In a preferred embodiment, the moisture content of a veneer layer is based on the average of several measurements across a representative portion of the layer.

LVL is normally characterized in that the wood grain in the veneers is oriented in the same direction for all plies so that higher strength than solid wood is obtainable. LVL is manufactured in a wide range of thicknesses (consequently using a wide number of veneer layers), with 1.5-3.5 inch thicknesses being representative. In general, plywood is constructed using an odd number of veneers, with adjacent veneer layers having their wood grain oriented perpendicular to each other. Representative wood varieties for use preparing veneers include, but are not limited to, soft woods (e.g., Southern pine, Douglas fir, and Ponderosa pine) and hard woods (e.g., oak, walnut and birch). Laminated veneer lumber (LVL) products are formed by adhesively bonding veneer faces as described in more detail below.

Unless otherwise explicitly indicated, component percentages of a composition are expressed as a percentage by weight.

As stated above, the adhesive composition used in the present invention comprises a thermosetting phenol-aldehyde resin having at least one of (A) a number average molecular weight (Mₙ) of at least about 450, (B) a weight average molecular weight (M_{w}) of at least about 2000, and (C) a Z-average molecular weight (M_{z}) of at least about 6000. Preferred embodiments include compositions having one of (A), (B), and (C); a combination of two of (A), (B), and (C); or all three of (A), (B), and (C). The composition further comprises a ketone-aldehyde resin cure promoter and optionally other components, depending on the specific use. A preferred range of Mₙ for the phenol-aldehyde resin of the adhesive composition is from about 450 to about 800, and a more preferred range is from about 500 to about 600. A preferred range of M_{w} for the phenol-aldehyde resin of the adhesive composition is from about 2000 to about 6000, and a more preferred range is from about 3000 to about 4000. A preferred range of M_{z} for the phenol-aldehyde resin of the adhesive composition is from about 6000 to about 14,000, and a more preferred range is from about 7000 to about 10,000 The polymerization degree and consequently the molecular weight of phenol-aldehyde resins is controlled by varying the “cooking” conditions, which include the reaction time and temperature of the reaction mixture of phenolic and aldehyde monomers. Normally, phenol-aldehyde resins are prepared by reacting these monomers at an elevated temperature under alkaline reaction conditions until sufficient condensation between the phenol and aldehyde has occurred to yield a condensation product with the desired molecular weight, which may be estimated from the viscosity and/or the refractive index of the reaction mixture. Specific reaction conditions are well-known to those skilled in the art.

Phenol-formaldehyde resins having values for Mₙ, M_{w}, and M_{z} as described above are generally considered too advanced (i.e., exhibiting too high of a polymerization degree) for effective use as an adhesive in the production of LVL, in view of the potential for glue line dryout described above. However, it has now been discovered that these resins, when used in combination with a ketone-aldehyde resin cure promoter and optionally other components as described herein, can provide superior resistance to both glue line dryout and steam blowout, associated with LVL manufacture from both low-moisture veneers and high-moisture veneers, respectively.

In addition to their use in manufacturing LVL, the adhesive compositions described herein may be used to adhesively bond lignocellulosic materials in general. Other materials that may be prepared therefore include plywood, hardboard, particleboard, fiberboard (e.g., medium density fiberboard), oriented strandboard (OSB), and waferboard, as known in the art and described in detail in U.S. Pat. No. 6,607,619. Other suitable materials include, but are not limited to, waffleboard, laminated lumber, wheat-board, flakeboard, parallel-laminated veneer, laminated beams, overlaid materials, wood-nonwood composites, edge-glued wood-based composite materials, other natural fiber boards (e.g., cellulosic fiberboards), other veneer-type products, and textile fiber mats (e.g., ceiling tiles and sound insulation). Commercially-available composites, including Timberstrand®, Parallam®, and Glulam® may also be made using the adhesive composition of the invention.

The phenol-aldehyde resin component of the adhesive composition of the present invention is a thermosetting polycondensate, in particular the polycondensation product of a phenol and an aldehyde. In conjunction with or in place of phenol (i.e., hydroxybenzene), phenolic components that may be used are resorcinol, cresol, pyrocatechol, cresylic acid, xylenols, naphthols, and polyphenols (e.g., bis-hydroxyphenyl alkanes such as 2,2′ bis-(4-hydroxyphenol)-propane). The aldehyde may be formaldehyde, or other aliphatic aldehydes including acetaldehyde and propionaldehyde may be used. Other aldehydes that may be used to generate the thermosetting phenol-aldehyde resin include aromatic aldehydes (e.g., benzylaldehyde and furfural), and other aldehydes such as aldol, glyoxal, and crotonaldehyde. Mixtures of aldehydes may also be used. Preferably, based on cost and convenience, formaldehyde is used. Preferably, the phenol-aldehyde resin is prepared from a mixture having a phenol:aldehyde mole ratio from about 0.38:1 to about 0.53:1. As used herein, “the phenol:aldehyde mole ratio” means the molar ratio of all phenolic components to all aldehydes used to prepare the thermosetting phenol-aldehyde resin. In most cases, this term simply refers to the mole ratio of phenol to formaldehyde, and a phenol-formaldehyde resin is preferred.

In addition to the thermosetting phenol-aldehyde resin, the adhesive of the present invention further comprises a ketone-aldehyde resin cure promoter, preferably an acetone-formaldehyde resin cure promoter. This resin cure promoter is prepared by reacting a ketone and an aldehyde in an aqueous reaction mixture in the presence of an alkaline catalyst. Procedures for the preparation of acetone-formaldehyde resins, which are also broadly applicable to the preparation of ketone-aldehyde resins that are suitably employed as the resin cure promoter of the present invention, are well known in the art and are described in detail, for example, in U.S. Pat. No. 4,915,766 at column 4, line 52 to column 6, line 7. As an alternative to using acetone, as described in the '766 patent, any number of ketones (e.g., dialkyl ketones, such as diethyl ketone) or mixtures of ketones may be substituted for acetone. Likewise, as an alternative to using formaldehyde, it is possible to use any of the aldehydes or mixtures of aldehydes described above for use in preparing the phenol-aldehyde resin.

Solutions or suspensions of both the phenol-aldehyde resin and the ketone-aldehyde resin cure promoter are generally supplied as mixtures with various fillers and extenders known in the art, in addition to the resin itself. Preferably, a phenol-aldehyde resin mixture has a resin solids content from about 28% to about 40% by weight. Likewise, the ketone-aldehyde resin cure promoter can also be a mixture containing predominantly filler and extender components, in which case the resin solids content of the mixture is preferably from about 33% to about 45%. Alternatively, the ketone-aldehyde resin cure promoter may be supplied as a “neat” form of essentially all resin component. Preferably, the adhesive composition of the present invention comprises a phenol-aldehyde resin mixture as described above, combined with either a ketone-aldehyde resin cure promoter mixture or a neat ketone-aldehyde resin cure promoter as described above. In either case, the ketone-aldehyde mixture or neat cure promoter preferably represents from about 5% to about 30%, and more preferably from about 10% to about 20%, by weight of the combined amount of (1) the phenol-aldehyde resin mixture and (2) either the ketone-aldehyde resin cure promoter mixture or the neat cure promoter. In general, the ketone-aldehyde resin cure promoter is preferably present in an amount from about 1% to about 20% by weight of the combined amount of phenol-aldehyde resin (in the phenol-aldehyde resin mixture described above) and the ketone-aldehyde resin cure promoter (in the ketone-aldehyde cure promoter mixture or the neat cure promoter described above). In view of the preferred resin solids contents for the phenol-aldehyde resin mixture and the ketone-aldehyde mixture as described above, the ketone-aldehyde resin cure promoter is more preferably present in an amount from about 2% to about 15%, and even more preferably present in an amount from about 3% to about 9%, by weight of the combined amounts of phenol-aldehyde resin and ketone-aldehyde resin cure promoter.

As mentioned above, although the thermosetting phenol-aldehyde resin has molecular weight characteristics of an advanced polymer, it is nevertheless suitable for use with low-moisture veneers, without the adhesive bond integrity being compromised by glue line dryout. This property of the adhesives of the present invention is contrary to conventional industry belief regarding the relationship between the phenol-aldehyde resin molecular weight and propensity for dryout. Because the overall composition of adhesives of the present invention are in fact resistant to dryout, they are suitable for making LVL from a plurality of wood veneers, wherein at least one of the veneers has a moisture content of less than about 7% by weight or the plurality of wood veneers has an average moisture content of less than about 10% by weight, and preferably has an average moisture content from about 1% to about 7% by weight, and more preferably from about 3% to about 7% by weight.

Due to the molecular weight characteristics described previously, corresponding to a relatively high degree of advancement, the thermosetting phenol-aldehyde resin used in the adhesive composition of the present invention cures quickly, making it especially suitable for thicker LVL products having multiple layers of adhesive that must achieve the proper curing temperature for a sufficient time. In a preferred embodiment, the adhesive of the present invention is therefore used with LVL comprising at least 13 veneers (typically at least about 1.5-inch thick LVL products), and more preferably LVL comprising from about 13 veneers to about 29 veneers (typically from about 1.5-inch thick to about 3.5-inch thick LVL products). However, the adhesive may also be used with LVL products that comprise more than 29 veneers and/or that are thicker than 3.5 inches.

The adhesive composition may optionally contain a compound to promote rapid tack-build, so that panels formed after an initial pre-pressing operation have sufficient structural integrity to withstand physical transfer to a subsequent hot-pressing or curing operation. This physical transfer may involve displacing the previously-cured panel in the production line. The need for rapid tack-build becomes more significant as productivity is increased and consequently the time allotted for the adhesive to gain tack strength between pre-pressing and hot-pressing operations is correspondingly decreased. Tack-promoters include soya compounds having a protein level of at least about 50% by weight, preferably at least about 70% by weight, and more preferably from about 70 to about 75% by weight. Suitable soya compounds having such protein levels are known in the art and are available from suppliers such as Archer Daniels Midland, Cenex Harvest States, Kansas State University, and others.

When soya compound tack-promoters are used in phenol-aldehyde resin-containing adhesive compositions of the present invention, such compositions are preferably capable of reaching a viscosity of 3000 centipoise in a time of less than about 20 minutes from initial mixing, at a temperature of 77° F. (25° C.). Adhesive compositions having such tack-building capability are preferably used for LVL products having a thickness in a range where tack-build is of considerable importance relative to curing characteristics. A preferred range is from about 1.5 inches to about 3.5 inches in thickness, wherein the LVL typically comprises from 13 to 29 wood veneers.

To further enhance curing of the adhesive, thereby allowing for a reduction in the severity (i.e. time, temperature, or both) of the hot-pressing operation needed to effect sufficiently strong adhesive bonding of the veneers, a catalyst may also be employed in the adhesive composition. Catalysts have been found especially effective for bonding high-moisture veneers, having the greatest possibility of wood failure due to steam blowout during and immediately after hot-pressing. Therefore, in a preferred embodiment, the adhesive composition of the present invention comprises a catalyst when the composition is used to bond wood veneers, wherein at least one of the veneers has a moisture content of greater than about 15% by weight or the plurality of wood veneers used to form a panel has an average moisture content of greater than about 10% by weight, preferably an average moisture content from about 10% to about 20% by weight, and more preferably an average moisture content from about 12% to about 15% by weight. Preferably, a suitable catalyst is selected from the group consisting of a carbamate (e.g., an alkyl carbamate such as ethyl carbamate), an ester (e.g., a saturated ester such as triacetin, an acrylic ester such as methyl methacrylate, or a vinyl ester such as vinyl acetate), a lactone (e.g., ε-caprolactone, γ-caprolactone, β-butyrolactone, β-propiolactone, β-butyrolactone, α-methyl-γ-butyrolactone, β-methyl-γ-butyrolactone, γ-valerolactone, δ-valerolactone, γ-nonanoic lactone, γ-octanoic lactone, or pentolactone), a carbonate (e.g., an alkyl carbonate, an alkenyl carbonate, or a cyclic carbonate such as propylene carbonate), and a compound having activated methylol groups (e.g., trimethylolnitromethane). When a catalyst is used, it is present preferably in an amount of greater than 1% by weight, and more preferably from about 1% to about 3% by weight, of the adhesive composition. An especially preferred catalyst is triacetin, having three acetate equivalents per molecule.

In addition to the fillers, extenders, tack-promoters and catalysts described above, the adhesive composition of the present invention may further comprise other cure promoters or accelerators (e.g., alkali metal and alkaline earth metal carbonates and hydroxides, such as sodium hydroxide), thickeners, adduct-forming agents (e.g., urea), and/or other tack promoters (e.g., borax). Such additives are known in the art and described, for example, in U.S. Pat. No. 4,915,766. Other cure accelerators also include, e.g., ammonium sulfate, sodium sulfate, aluminum sulfate, resorcinol-formaldehyde resin (RF), phenol-resorcinol-formaldehyde (PRF), and hexamethylenetetramine.

In the manufacture of LVL from a plurality of wood veneers, the adhesive composition as described above is applied to one or more veneer mating surfaces (i.e. surfaces to be bonded to adjacent veneers). The adhesive is generally applied in an amount from about 35 to about 55 pounds, preferably from about 45 to about 50 pounds, per 1000 square feet of single glue line (lb/Mft² SGL). The adhesive may be applied by any conventional method known in the art, including curtain coating, sprayline, foam extrusion, liquid extrusion, and roll coating. Preferably, the adhesive is applied by curtain coating.

In one embodiment, the components of the adhesive described above are mixed either batchwise or continuously (e.g., using in-line mixing) prior to applying the adhesive onto the wood veneer mating surfaces. Preferably, the thermosetting phenol-aldehyde resin and the ketone-aldehyde resin cure promoter components are mixed continuously prior to or coincident with the application of the adhesive to a mating surface of a veneer. As used herein, the term “continuously” is meant to include not only a strictly continuous activity, but also an intermittent activity that, because of the frequency of its repetition, approximates the result obtained from continuous activity. In an especially preferred embodiment, these components are mixed prior to, or coincident with, the adhesive application to a veneer mating surface, such that the phenol-aldehyde resin and ketone-aldehyde resin cure promoter are mixed in proportions that depend on at least one of a measured veneer moisture level and a measured temperature. This type of feedback control is described in U.S. Pat. No. 6,607,619 which teaches the in-line mixing of adhesive components prior to application to the veneer mating surfaces. In this manner, the adhesive composition may be continuously adjusted in response to changes in processing conditions. Alternatively, the mixing of adhesive components continuously during its application to wood veneer may be accomplished, e.g., when the application comprises applying the phenol-aldehyde resin onto the veneer mating surface by curtain coating and thereafter spraying or misting the ketone-aldehyde resin cure promoter onto the phenol-aldehyde resin.

In the same manner as described above for the thermosetting phenol-aldehyde resin and the ketone-aldehyde resin cure promoter components of the adhesive, the above-described tack-promoters, catalysts, and other components of the adhesive may be similarly mixed batchwise or continuously into the adhesive composition. Continuous mixing may be performed prior to, or coincident with, the adhesive application to a veneer mating surface. Likewise, any of the adhesive composition components may be added prior to, or coincident with, the adhesive application to a veneer mating surface in amounts that depend on at least one of a measured veneer moisture level and a measured temperature. In a preferred embodiment, therefore, when the adhesive composition comprises a soya compound as a tack-promoter, the thermosetting phenol-aldehyde resin, ketone-aldehyde resin cure promoter, and soya compound are mixed continuously prior to, or coincident with, the adhesive application to a veneer mating surface, and these components are mixed in proportions that depend on at least one of a measured veneer moisture level and a measured veneer temperature. The same considerations apply when the adhesive composition comprises a catalyst or other adhesive component as described above, instead of or in addition to a tack-promoter. In fact, addition of any adhesive component, where the amount of that component is critically dependent upon a measured process variable, may be accomplished using feedback control as described in the above-reference U.S. Pat. No. 6,607,619.

The ketone-aldehyde resin cure promoter can be added separately to the phenol-aldehyde resin component of the adhesive composition where the cure promoter is needed in LVL billet construction to maximize the speed of curing and minimize the cost of adhesive materials. In the case of curtain coating, a process well known in the art, such an application may be the addition of the ketone-aldehyde resin cure promoter being sprayed or misted into the adhesive curtain as it is being applied to the veneers. Another technique involves the application of the ketone-aldehyde resin cure promoter by in-line mixing with the phenol-aldehyde resin component at the curtain coater head, where the cure promoter addition may be turned on or off as needed. In this manner, the adhesive composition may be applied to the center one third of the billet thickness, with the outer one third of both sides of the billet construction having phenol-formaldehyde adhesive applied without the ketone-aldehyde resin cure promoter.

As stated previously, the adhesive compositions of the present invention are advantageously used in manufacturing LVL from low moisture veneers, for example, those having an average moisture content from about 3% to about 7% by weight. This level of veneer moisture is commonly used in LVL constructions having a total thickness ranging from about 1.5 to about 3.5 inches. However, adhesive compositions of the present invention may also be used to manufacture much thicker LVL constructions than those currently manufactured. Low moisture veneers are commonly used with relatively thick LVL billets, since such billets inhibit the free escape of moisture during high temperature press curing. Surprisingly, however, adhesive compositions of the present invention allow high moisture veneers to be used in thick LVL constructions without substantially promoting a loss of the final billet integrity due to the escape of steam (i.e., steam blowout). Currently, for example, 3.5-inch thick LVL beams can be used to replace 2×4 inch thick Glulam® beams in construction applications.

It is also possible for adhesive compositions of the present invention to be used in combination with faster heat transfer pressing technologies such as radio-frequency (RF) or microwave heating or in combination with conventional hot pressing technology to permit the manufacture of much thicker LVL constructions than those conventionally produced. Generally, beams of thicker constructions, such as those found in architectural structures having thickness up to 12 inches or greater, are prepared in off-site setups with clamps and presses using room temperature curing adhesives such as resorcinol and phenolic-modified resorcinol adhesives. These adhesives require long curing times as well as careful, labor-intensive application methods. With the use of adhesive compositions of the present invention in combination with any of a number of processes for producing LVL products, LVL beams can be produced continuously with a high length dimension and often at significantly lower cost, compared to the same processes using conventional adhesives. In LVL manufacturing operations, wood veneer thickness can be altered to produce, for example, beams having veneer thickness from 0.10 to 0.25 inches. Thicker LVL billets are generally pressed under conventional LVL presses at higher pressure and temperature, not only due to billet thickness, but also due to the associated overlap joints at each adjoining veneer, which must be pressed to the correct billet thickness. Press pressures can be applied from 190 psig to 350 psig and press temperatures can range from 285° F. (140° C.) to greater than 345° F. (174° C.). Overall, the use of adhesive compositions of the present invention can extend the scope of what products can possibly be manufactured as well as add flexibility to the conditions used in the current manufacture of LVL products.

Adhesive compositions of the present invention allow for the bonding of low moisture veneers at faster cure speeds than the conventional LVL adhesives. For example, a 29% reduction in press time needed for curing was accomplished for a 3.5 inch billet, compared to the present fastest conventional phenolic adhesive without a ketone-aldehyde resin cure promoter, using conventional LVL presses without any additional energy source such as microwave or radio frequency radiation. Adhesives of the present invention will retain reactivity on dry, warm veneer for periods up to and exceeding 45 minutes open assembly time, whereas conventional LVL adhesives under the same conditions experience dryout on glue lines, thus losing bond strength, as evidenced by a decrease in percent wood failure values, determined using a standard bond strength measurement test. As certain LVL adhesive compositions of the present invention are allowed to age in a mixed state, their viscosities can increase to 3500 to 4000 centipoise in a short time, resulting in a fast build up of tack properties that maintain consolidation of the veneer components as the consolidated billet exits the pre-pressing operation. With conventional LVL adhesives, good pre-press consolidation of veneers is dependent upon batch-to-batch variations in adhesive properties, and often an unacceptably long press cycle is found to be necessary due to problems associated veneer slippage and lack of adhesive tack strength generally after pre-press. In general, conventional LVL adhesives impose limitations on veneer moisture content and overall billet thickness. The LVL adhesive compositions of the present invention, in contrast, extend the range of billet thickness allowed because of their resistance to dryout at low to moderate veneer moisture levels (e.g., between 7 and 13% by weight).

After application of adhesive to one or more mating surfaces of wood veneer, forming LVL is normally effected first by forming a panel or billet by pressing layers of wood veneer together after adhesive has been applied between these layers. The uncured adhesive, which provides tackiness during panel formation and thereby keeps the wood veneers properly aligned, is thereafter cured to yield the LVL product. It is possible to form LVL in a single step after adhesive is applied to veneer mating surfaces. Typically, however, LVL is formed in at least two steps. The first step comprises pre-pressing surfaces of wood veneers, to which adhesive has been applied, under pre-pressing conditions to form a panel. The next step comprises hot-pressing the panel at curing conditions to cure the adhesive.

Preferably, pre-pressing conditions include ambient temperature, a pressure from about 150 psig to about 175 psig, and a time of less than about 10 minutes. As described above, the degree of pre-pressing is just sufficient to produce panels that resist delamination under normal conditions of storage and handling. While long holding times between pre-pressing and subsequent hot-pressing cycles are known to promote undesired dryout of glue lines, the adhesive compositions of the present invention effectively resist such dryout even for dry veneers, wherein at least one of the veneers has a moisture content of less than about 7% by weight or the plurality of wood veneers to be bonded has an average moisture content of less than about 10%. Under these conditions, adhesive compositions of the present invention provide excellent bonding (uncharacteristic of dryout), even when hot-pressing is not conducted until at least about 30 minutes after pre-pressing. If a catalyst such as triacetin is employed, dryout resistance may be even further improved to accommodate a 45-minute delay or longer between pre-pressing and hot-pressing.

After pre-pressing, hot-pressing is conducted to carry out or complete the cure of the thermosetting phenol-aldehyde resin. Hot-pressing conditions preferably include a temperature from about 285° F. (140° C.) to about 345° F. (174° C.), a pressure from about 190 psig to about 350 psig, and a time from about 1 minute to about 1 hour. As is known in the art, these conditions depend on the degree of resin advancement, veneer moisture content, veneer thickness, overall panel thickness, and other factors. For the relatively advanced thermosetting phenol-aldehyde resin of the present invention, shorter hot-pressing times, preferably from about 2 to about 5 minutes, are usually sufficient to effect good bonding characteristics. When high moisture veneers are used, hot-pressing conditions are at the lower ends of the illustrative temperature and pressure ranges provided above, in order to minimize occurrences of steam blowout. The rate at which adhesive is applied to veneers can be adjusted within the competence of one skilled in the art in order to realize the competing objectives of both minimizing glue line dryout and steam blowout.

Alternatively, curing temperatures and pressures may be reduced when the adhesive is cured using radio frequency or microwave frequency curing techniques known in the art. These radiation-curing methods may be used alone or in combination with hot-pressing, wherein the above-described advantages associated with the adhesives of the present invention are retained.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references. In view of the above, it will be seen that several advantages of the invention are achieved and other advantageous results obtained.

As various changes could be made in the above methods and compositions without departing from the scope of the invention, it is intended that all matter contained in this application shall be interpreted as illustrative only and not limiting in any way the scope of the appended claims.

The following examples are set forth as representative of the present invention. These examples are not to be construed as limiting the scope of the invention as these and other equivalent embodiments will be apparent in view of the present disclosure and appended claims.

### EXAMPLE 1

A comparison was made among several adhesive compositions, in terms of the bonding strengths obtained in the preparation of LVL billets. Preparation conditions used for these comparative tests, including pre-pressing and hot-pressing conditions were maintained as close to the same as possible and within the standard conditions recited herein. The phenol-formaldehyde (PF) component of the adhesive used in each test had Mₙ, M_{w}, and M_{z} values ranging from about 450-550 g/mol, 2200-3000 g/mol, and 6000-8900 g/mol, respectively. An acetone-formaldehyde (AF) resin cure promoter was added to the adhesive composition in varying amounts. Adhesive bond quality was analyzed according to ASTM D-5266-97 (Standard Quality Practice for Estimating the Percentage of Wood Failure in Adhesive Bond Joints), which measures the wood failure percentage when the glue line of an LVL sample is sheared apart. Thus, a higher wood failure rate is indicative of a lower adhesive failure rate and directionally indicates a stronger adhesive bond.

In this example, (1) a PF resin-based adhesive mixture (containing fillers, extenders, and 28-40% resin solids), (2) a PF resin-based adhesive mixture, combined with neat AF resin cure promoter in a weight ratio of 87/13 PF resin-based adhesive mixture/AF resin cure promoter, (3) a PF resin-based adhesive mixture, combined with an AF resin-based cure promoter mixture (containing fillers, extenders, and 33-36% resin solids) in a weight ratio of 80/20 PF resin-based adhesive mixture/AF resin-based cure promoter mixture, and (4) a PF resin-based adhesive mixture, combined with neat AF resin cure promoter and triacetin in a weight ratio of 86/13/1 PF resin-based adhesive/AF resin cure promoter/triacetin. Billets made with adhesives (1) and (2) had a wood failure of below 50% while billets made with adhesives (3) and (4) had a wood failure of greater than 80%. This example illustrates the adhesive bond improvement obtained when (i) AF resin cure promoter, either in neat form or as a resin-based mixture and/or (ii) triacetin are added to conventional PF resin-based LVL adhesives.

### EXAMPLE 2

Two LVL billets were made according to essentially identical and standard procedures described herein. The adhesive used to prepare the LVL billets comprised a PF resin-based adhesive mixture, as described in Example 1, which was combined with an AF resin-based cure promoter mixture, as described in Example 1 and a triacetin catalyst. These components were combined in weight ratios of 88.8/10/1.2 (Billet 1) and 81/18/1 (Billet 2), of PF resin-based adhesive mixture/AF resin-based cure promoter mixture/triacetin. Billet 2 showed improved bonding relative to the Billet 1, according to ASTM D-5266-97, described in Example 1. This example further demonstrates the direction improvement in bonding strength achieved as AF resin cure promoter is added to the adhesive composition.

### EXAMPLE 3

Bonding of Catalyzed and Uncatalyzed Adhesives to Different Moisture Veneers

This example demonstrates the diversity of adhesive compositions of the present invention in performing under a variety of veneer moisture levels ranging from dry (2% veneer moisture) to moderate (7% veneer moisture) to wet (12% veneer moisture) conditions. A designed experiment (Box Behnken) was carried out using the PF resin-based adhesive mixture (1) as described in Example 1 (i.e., the designated Control Adhesive) and mixture (3) as described in Example 1 (i.e., the designated Present Invention Adhesive, namely, a PF resin-based adhesive mixture, combined with an AF resin-based cure promoter mixture in a weight ratio of 80/20 PF resin-based adhesive mixture/AF resin-based cure promoter mixture). Under the designed experiment, the amount of adhesive applied to the glue lines of the composites ranged from 29 to 40 lbs/1000 square feet of single glue line (lb/Mft² SGL), and the hot press time at 315° F. (157° C.) was varied between 2.2 minutes and 3.0 minutes. Three-ply laminates were used to screen the effect of these independent variables on the wood failure at the center glue lines, measured according to ASTM D-5266-97, as described in Example 1. The following average percent wood failures obtained using each adhesive are shown in Table I.

TABLE I
Comparison of Control Adhesive and Present Invention Adhesive
Under All Test Conditions, (Percent Wood Failure)

| | | Present Invention Adhesive |
|---|---|---|
| | Control Adhesive | 80% PF Resin Mixture/ |
| Veneer Moisture | PF Resin Mixture | 20% AF Resin Mixture |
| (%) | (% Wood Failure) | (% Wood Failure) |
| 2% | 69% | 75% |
| 7% | 77% | 82% |
| 12% | 74% | 79% |

Column 1 shows the moisture content of the center veneer, with outer veneers having 7% moisture. The second column shows the average percent wood failure for LVL produced using adhesive compositions comprising a PF resin-based adhesive mixture Control Adhesive, without added AF resin cure promoter. The third column shows the average percent wood failure for LVL produced using the Present Invention Adhesive (i.e., comprising an AF resin cure promoter). These results show the improved bonding at all veneer moisture conditions when the PF resin adhesive further comprises an AF resin cure promoter, optionally containing fillers, extenders, and other additives.

### EXAMPLE 4

Cure Speed of Adhesives in 1.75-Inch LVL Billets

In this example, the cure speeds were compared between the Control Adhesive and the Present Invention Adhesive, as described in Example 3. The adhesives were applied at 38 to 42 lb/Mft² SGL onto southern yellow pine veneers and laid up as 15-ply LVL, 1.75-inch thick billets. Hot-pressing times were varied while monitoring the center ply glue line temperature with a thermocouple. After the pre-planned press time expired the billets were removed from the hot press and placed in an insulated hot stack box for 30 to 90 minutes before chiseling the center plies to determine the amount of adhesive bonding by measuring the percent wood failure according to ASTM D-5266-97, as described in Example 1.

The following Table II provides a comparison between the Control Adhesive and the Present Invention Adhesive. The veneer thickness was 0.125 inches and moisture contents between 6 and 8% were used to make the 1.75-inch thick billets. Press conditions of 340° F. (171° C.) and 275 psig were used.

TABLE II
Comparison of Control Adhesive and Present Invention
Adhesive, % Wood Failure vs. Press Times for 1.75 inch Billets

| | | | |
|---|---|---|---|
| Press | | | |
| Times, | Center Glue Line | % Wood Failure | % Wood Failure |
| minutes | Temp. ° F. | 30 minute Hot Stack | 90 minute Hot Stack |

Control Adhesive, PF Resin Mixture

| | | | |
|---|---|---|---|
| 20 | 205 | 65% | 100% |
| 19 | 209 | 75% | 95% |
| 18 | 196 | 45% | 85% |
| 17 | 205 | 10% | 20% |
| 16.5 | 184 | Delamination | Delamination |

Present Invention Adhesive, 80% PF Resin
Mixture/20% AF Resin Mixture

| | | | |
|---|---|---|---|
| 16 | 221 | 85% | 90% |
| 15 | 193 | 80% | 85% |
| 14.5 | 181 | 75% | 95% |
| 14 | 180 | 35% | 80% |

This example shows that the addition of 20% by weight of AF resin-based cure mixture to the PF resin-based adhesive mixture Control Adhesive accelerates the cure by about 3 minutes. The minimum press time for the Control Adhesives that produced an acceptable bond (i.e., at least 80% average wood failure rate) was 18 minutes. For the Present Invention Adhesive with 20% by weight AF resin-based cure promoter mixture, this time was reduced to 14.5 minutes, an improvement of 3.5 minutes, compared to the Control Adhesive. The use of the Present Invention Adhesive therefore allows the rate of 1.75-inch thick LVL production to be correspondingly increased.

### EXAMPLE 5

Cure Speed of Adhesives in 3.5-Inch LVL Billets

In this example, for thicker billets, the cure speed of the adhesive was evaluated and compared between the Control Adhesive and the Present Invention Adhesive, as described in Example 3. The adhesives were applied at 55 to 58 lb/Mft² SGL onto southern yellow pine veneers and laid up as 28-ply, 3.5-inch thick LVL billets. During hot-pressing the press times were varied while monitoring the center ply glue line temperature with a thermocouple. After the pre-planned press time expired the billets were removed from the hot press and placed in an insulated hot stack box for 30 to 90 minutes before chiseling the center plies to determine the amount of adhesive bonding by measuring the percent wood failure, according to ASTM D-5266-97, as described in Example 1.

The following Table III provides a comparison between the performance of the Control Adhesive and the Present Invention Adhesive. The veneer thickness was 0.125 inches and moisture contents between 6 and 8% were used to make the 3.5-inch thick billets. Press conditions of 340° F. (171° C.) and 275 psig were used.

TABLE III
Comparison of Control Adhesive and Present Invention Adhesive
% Wood Failure vs. Press Times for 3.5 inch Billets

| | | | |
|---|---|---|---|
| Press | | | |
| Times, | Center Glue Line | % Wood Failure | % Wood Failure |
| minutes | Temp. ° F. | 30 minute Hot Stack | 90 minute Hot Stack |

Control Adhesive, PF Resin Mixture

| | | | |
|---|---|---|---|
| 50 | 171 | 85% | 95% |
| 48 | 165 | 60% | 90% |
| 48 | 161 | 80% | 85% |
| 47 | 165 | 50% | 70% |
| 46 | 158 | 40% | 70% |

Present Invention Adhesive, 80% PF Resin
Mixture/20% AF Resin Mixture

| | | | |
|---|---|---|---|
| 46 | 161 | 80% | 85% |
| 40 | 148 | 65% | 90% |
| 38 | 150 | 75% | 95% |
| 36 | 136 | 55% | 80% |
| 34 | 131 | 70% | 90% |
| 32 | 129 | 40% | 75% |
| 28 | delamination | 0% | 0% |

This example demonstrates that the addition of 20% by weight of AF resin-based cure promoter mixture to the PF resin-based adhesive mixture Control Adhesive composition accelerates the cure by about 14 minutes. The minimum press time for the Control Adhesive that produced an acceptable bond (i.e., at least 80% wood failure rate) was 48 minutes. For the Present Invention Adhesive with 20% by weight AF resin-based cure promoter mixture, this time was reduced to 34 minutes, an improvement of 14 minutes over the Control Adhesive. The use of the Present Invention Adhesive therefore allows the rate of 3.5-inch thick LVL production to be correspondingly increased.

### EXAMPLE 6

Effects of Catalyst and Additives on the Tack Development of Adhesives

In the batch process of making LVL, veneer is passed through a curtain coater, or other means of applying the adhesive and laid up on a moving table with the grain of veneer layers running the same direction to form the uncured LVL billet. Upon completion of the lay-up, generally having 13 to 29 piles, the billet is then pre-pressed at 150 to 175 psig to consolidate the veneers and allow for the transfer of adhesive to the adjacent veneer's mating surface. This pre-pressing operation can take 2 to 6 minutes followed by a closed assembly stand-time while waiting for the hot press to complete curing of the previous billet. Stand times can be as long as 40 to 55 minutes or as short as 12 to 20 minutes depending on the thickness of the billet. Since these billets can be as long as 100 feet and the lay-up is generally in 8 foot sections followed by the pre-pressing of up to 16 foot sections, the pre-pressed billet must remain assembled to prevent dryout during those long stand-times and also have enough tack building strength during shorter dwell times to push the previous billet out of the hot press while being loaded in the hot press. Not only must the adhesive cure faster for different billet thicknesses to improve productivity, but also the adhesive must be able to develop tack strength in a short period of time and maintain billet consolidation, in order to prevent the un-cured billet from collapsing as it pushes the cured billet out of the hot press.

To accomplish this dual purpose, the adhesive composition of the present invention preferably includes a PF resin with a sufficiently high molecular weight, having been “cooked” at carefully controlled process parameters, including alkalinity, phenol:formaldehyde molar ratio, viscosity, and resin solids. In addition, the PF resin may be formulated into an adhesive mixture containing fillers, extenders, surfactants, tack-promoters, and other additives, which promote fast tack building strength while minimizing the potential for glue line dryout. Other properties of the adhesive mixture that may be varied to affect this tack-building property include total non-volatile solids, alkalinity, and viscosity. Tack-promoters can be included in the manufacturing of the PF resin, added to the adhesive mixture, or both. Once the PF resin is formulated into an adhesive, fillers, extenders and other additives may be mixed with the PF resin followed by an alkalinity digestion of protein components to build an acceptable viscosity, which will allow for the proper viscosity range for curtain coating applications.

As discussed above, the resulting adhesive is enhanced by the addition an AF resin cure promoter to provide an adhesive composition of the present invention. Adhesives of the present invention may be formulated to have enhanced tack-building properties compared to conventional LVL or plywood adhesives, as shown in Table IV, since conventional adhesives tend to have limited tack-building and cure speed characteristics. Furthermore, the addition of an AF resin cure promoter to the PF resin in adhesive compositions of the present invention, together with selected fillers, extenders, surfactants, tack-promoters and other additives, may further improve the tack-building properties of adhesives of the present invention. Soya compounds, for example, can further improve the tack-building property of PF resin/AF resin cure promoter mixtures by adding another source of tack. Soya compounds found to be acceptable are those that have a high level of available protein, including but not limited to, soy protein concentrates having protein levels as high as 70 to 75 percent.

### EXAMPLE 7

To investigate the tack-building strength of adhesives of the present invention comprising a soya compound, the soya compound used was defatted and therefore contained low levels of fatty acids and had a protein content in the range of 55 to 60%. A tensile jig was built to fit an Instron or Tinius-Olson tester. This jig accepted a three-ply billet or panel where the two outer plies measured 12″×12″ and the center ply measured 10″ by 12″. The panel or billet was laid up, allowed to stand in an open assembly time for 2 to 4 minutes, pre-pressed at 150 psig for time shown in Table IV, and then allowed to stand in a closed assembly for 30 minutes from the start of the lay-up. The panels or billets were placed in the jig and pulled apart. The force required to separate the billets was recorded to indicate the tack building strength of the adhesive at different pre-press time intervals

TABLE IV
Tack-Building Strength of Adhesives (in Pounds to Delaminate
Veneers) as a Function of Pre-Press Time

| | Pre-Press Time | | | |
|---|---|---|---|---|
| | 2 minutes | 3 minutes | 5 minutes | 10 minutes |
| Adhesive Type | Lbs. | Lbs. | Lbs. | Lbs |
| Conventional | 13 | 14 | 23 | 37.5 |
| Adhesive | | | | |
| Control Adhesive | 14 | 35.6 | 47 | 59.5 |
| Present Invention | 18.8 | 34.3 | 44.6 | 59.4 |
| Adhesive System # 1 | | | | |
| Present Invention | 22 | 36.1 | 50.5 | 68.4 |
| Adhesive System # 2 | | | | |
| Present Invention | 27.1 | 43 | 52.6 | 68.3 |
| Adhesive, High | | | | |
| Protein System #3 | | | | |

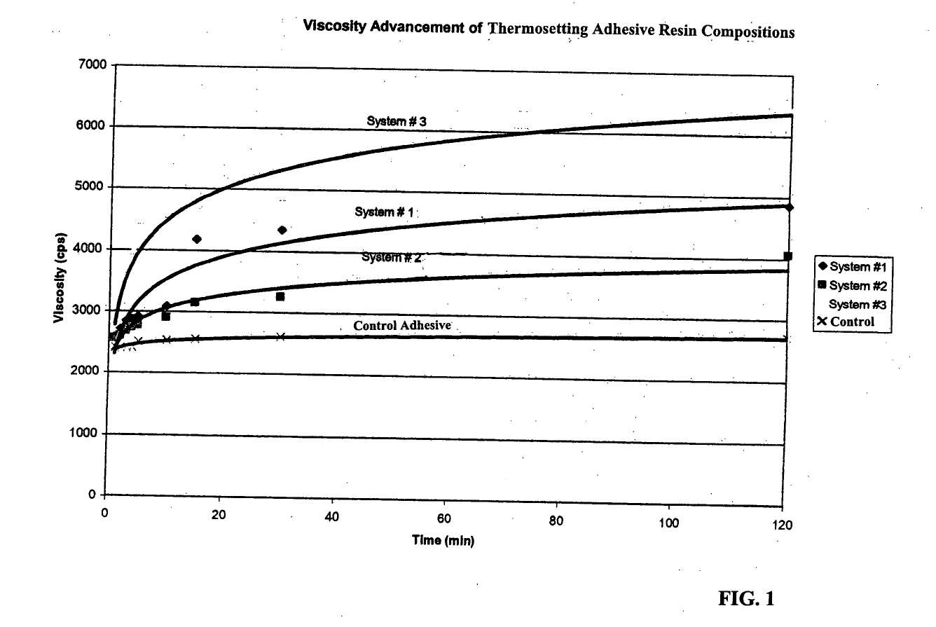

The results of this test show the lower pre-press tack-building property of a standard LVL or plywood resin mixture (designated “Conventional Adhesive” in Table IV), compared to the PF resin-based adhesive mixture of Example 3, or Control Adhesive, having PF resin molecular weight characteristics of “advanced” resins as described above and in accordance with the present invention. The composition designated “System 1” in Table IV is the Present Invention Adhesive, described in Example 3, comprising an AF resin cure promoter. This composition is suitable for manufacturing LVL products having a thickness of about 3.5 inches in which the manufacturing process relies less on tack and more on hot press curing speed. As a result, the “System 1” composition or Present Invention Adhesive has a slight improvement in tack building during the first few minutes, compared to that of the Control Adhesive (without AF resin cure promoter), but otherwise approximately matches the tack-build profile of the Control Adhesive. For thin LVL products (e.g, 1.5 to 1.75 inches), the adhesive composition designated “System 2”, comprising soya compounds for tack-building enhancement, and the composition designated “System 3” comprising AF resin cure promoter combined with high protein, each showed improved tack building during the first few minutes. The replacement of some of the wheat extender solids with soy protein solids having 55 to 60% protein in the “System 3” composition greatly increased the tack building properties of the AF resin cure promoter. The tack building property, in terms of pounds of force to pull apart the pre-pressed panels or billets, is important in maintaining billet integrity during further processing of the uncured billet. Related to this force (or billet integrity), is the viscosity of these adhesive compositions reached as a function of time, which is graphically illustrated in FIG. 1. FIG. 1 clearly demonstrates the tack-building properties of these compositions over a 120-minute time period.

As shown in FIG. 1, the Control Adhesive shows a fairly flat viscosity curve over the 120-minute time period. The System #2 adhesive for the thicker 3.5-inch LVL products showed a slight increase in viscosity within the first 10 minutes of mixing, followed by a slightly upward slope of the curve over the next 110 minutes. For the thinner LVL products, generally in the 1.5 to 1.75 inch thickness range, System #1 shows a more rapid increase in the viscosity curve over the first 30 minutes after mixing. For very fast tack build-up systems needed for cold and inclement weather, a high protein level adhesive such as System #3 showed the most rapid increase in viscosity during the first 30 minutes with increased viscosity over the total 120 minutes. With the use of in-line mixing and metering catalyst equipment, these systems allow for good processing over wide-ranging conditions because of the short residence times of adhesives of the present invention, resulting from the small amount of adhesive that is retained in the application equipment during a 15-30 minute time period. System #3 would also be very adaptable to in-line AF resin cure promoter addition using newer extruder equipment for LVL mills, for example, that designed by SPAR-TEK of Portland, Oreg.

### EXAMPLE 8

Use of Present Invention Adhesives with a Catalyst For High Moisture Veneer Bonding

Typically, veneers used in manufacturing of LVL billets are dried to a 2 to 8% moisture content to eliminate delamination due to pressure blows. A pressure blow results from the pressure of vaporized veneer moisture and/or moisture from the adhesive building up within the billet to a level sufficient to compromise the strength of the adhesive bond holding the veneers together, upon release of the pressure after hot pressing. The pressure blow occurs when the hot press opens, reducing the hot press pressure, for example, from 175 psig to atmospheric pressure. Adhesives of the present invention can speed the cure of the PF resin, allowing for lower temperature curing, after the resin mechanically and chemically reacts with the veneer surface. This helps to reduce or eliminate pressure blows caused by moisture. Generally, veneers are measured for their moisture content before the adhesive is applied to the veneer surface. If the moisture exceeds an established limit, the veneer is re-routed to a drop bin on line to eliminate it from causing a pressure blow in the final product. Manufacturers are continually attempting to increase moisture tolerances because of environmental concerns about dryer emissions and also because of the desirability of increased veneer processing capacity through the driers.

It has now been found that the addition of a catalyst to adhesive compositions comprising a PF resin/AF resin cure promoter system can further reduce the effects of higher moisture veneers or veneers that contain pockets of moisture in the range of 10 to 14% by weight. This has now been shown in laboratory experiments to effectively allow for higher moisture veneers to be bonded with resulting strengths in the range of 80% or higher wood failure when tested by the APA PS-1 vacuum/pressure water soak cycle test (APA PS-1 test). An especially effective catalyst additive is triacetin. Other possible catalysts include carbamates, esters, lactones and carbonates such as ethylene or propylene carbonate or mixtures of these carbonates. Also suitable for use as a catalyst additive are compounds such as trimethylolnitromethane, having activated methylol groups. In one of the tests to show the effects of a catalyst-containing system on bonding, the outer plies of the panel or billet had moisture contents of 6 to 7% by weight, followed by the adjacent “next” inter-plies having moisture content of 10% and, adjacent to those plies, “next” inter-plies with 15 to 17% veneer moisture. The remainder of the panel or billet had 6 to 7% moisture veneers for the innermost plies. Thus, the high moisture veneer was sandwiched in the panel or billet as the third veneer from the top and/or bottom and surrounded by one 6 to 7% moisture veneer on the inside and one 10% moisture veneer on the outer side. The non-volatile solids of the adhesives generally ranged from 42 to 44% with spreads of approximately 34 to 38 lb/Mft² SGL, such that additional water from the adhesive was also present in the lay-up. The assembled panel or billet was allowed to stand in an open assembly for 15 to 20 minutes, pre-pressed for 4 minutes at 150 psig with no heat, and then hot pressed at a temperature ranging from 315° F. to 340° F. (157° C. to 171° C.) until the center glue line temperatures reached at least 190° F. (88° C.). The billets were hot stacked overnight (12 to 16 hours) and then checked for bonding on both sides of the 15 to 17% moisture veneers. The results of this severe test are shown in the following Table V.

In this example, the bonding properties of various adhesive compositions were compared using the wood failure test ASTM D-5266-97, described in Example 1. Thus, the effect of moisture content of the veneers being bonded was evaluated. In particular, the first column of Table V shows the wood failure rate associated with the adhesive bond between the 6-7% moisture veneer and the 10% moisture veneer; the second column shows this rate associated with the adhesive bond between the 10% moisture veneer and the 17% moisture veneer; and the third column shows this rate associated with the adhesive bond between the 17% moisture veneer and the 6% moisture veneer. The Control Adhesive refers to the PF resin-based adhesive mixture, as described in Example 3. This Control Adhesive was compared to various adhesive formulations of the present invention, comprising the Control Adhesive, combined with AF resin-based cure promoter mixture, as described in Example 1, and optionally triacetin in the weight ratios provided in Table V.

TABLE V
Percent Wood Failure of PF Resin-Based Adhesive Mixture (Control
Adhesive) and the Control Adhesive Combined with Varying
Amounts of AF Resin-Based Cure Promoter Mixture and
Optionally Triacetin Catalyst at High Moisture Veneer Glue Lines

| | Bonding of | Bonding of | Bonding of |
|---|---|---|---|
| | 6 to 10% | 10 to 17% | 17 to 6% |
| | Moisture | Moisture | Moisture |
| Adhesive | Veneers | Veneers | Veneers |
| Control Adhesive | 15% | 0% | 0% |
| Control Adhesive with | 90 to 95% | 5% | 30 to 40% |
| 15% AF Resin Mixture | | | |
| Control Adhesive with | 90 to 100% | 30 to 40% | 50 to 65% |
| 20% AF Resin Mixture | | | |
| Control Adhesive with | 90 to 95% | 65% | 80% |
| 14% AF Resin Mixture | | | |
| and 1% Triacetin | | | |
| Control Adhesive with | 90% | 50% | 90% |
| 13.5% AF Resin | | | |
| Mixture and 1.5% | | | |
| Triacetin | | | |
| Control Adhesive with | 85 to 95% | 70% | 80 to 90% |
| 7% AF Resin Mixture | | | |
| and 3% Triacetin | | | |

These tests showed the improvement in bonding, as measured by percent wood failure, for the high moisture veneer glue lines studied in this example. As described above, the first column shows moderate moisture conditions of bonding between 6% moisture veneer and 10% moisture veneer. This bonding improved with the addition of the AF resin-based cure promoter mixture at levels of 15% and 20% by weight. The catalyst addition also improved bonding, especially under the high moisture conditions, in which the glue line was sandwiched between a 10 and a 17% moisture veneer. In this service, the bonding, as measured by percent wood failure, improves directionally with the addition of 1-3% by weight of triacetin catalyst. Even better results are obtained for the triacetin-containing compositions used in the glue line between the 6 to 17% moisture veneers. While it is not typically recommended that billets be made with veneers of 10 to 17% moisture, improvement can nevertheless be seen with veneer moisture contents above the normal 6 to 8% range. Thus, the potential exists for the use of higher moisture veneers with adhesives of the present invention, and this is especially the case when a catalyst such as triacetin is employed in the adhesive composition. Even under conventional LVL manufacturing operations, if an occasional higher moisture veneer should pass through the moisture testers without being screened out, the use of adhesive compositions of the present invention and comprising a catalyst such as triacetin would help prevent moisture pocket blows in the panels or billets produced.

### EXAMPLE 9

Shear Block Testing of Thick LVL Billets, Catalyzed vs. Uncatalyzed

To evaluate the performance of LVL made with adhesives of the present invention, billet samples were produced and compared for both shear strength and percent wood failure. The results of these tests are summarized in Table VI, which compares the performance of the Control Adhesive to the Present Invention Adhesive, as described in Example 3.

TABLE VI
Comparison of Control Adhesive and Present Invention
Adhesive for Block Shear Tests

| | Assembly | Shear | Percent Wood |
|---|---|---|---|
| | Times | Tests | Failure |
| Adhesive System | minutes | psig | % |
| Control Adhesive, dry | 20 | 1105 | 98.5 |
| Control Adhesive, V/P test | 20 | 848 | 98.3 |
| Control Adhesive, dry | 48 | 1072 | 98.7 |
| Control Adhesive, V/P test | 48 | 842 | 98 |
| Present Invention Adhesive, dry | 20 | 1062 | 98 |
| Present Invention Adhesive, | 20 | 932 | 97.1 |
| V/P Test | | | |
| Present Invention Adhesive, dry | 48 | 1329 | 96.5 |
| Present Invention Adhesive, | 48 | 1032 | 94.1 |
| V/P Test | | | |

ASTM D-905 is the standard method for “Strength Properties of Adhesive Bonds in Shear by Compressive Loading”. The tests were run on both dry specimens and specimens subjected to a modified APA vacuum/pressure water soak cycle test, described in the APA PS-1 test method. In particular, the test method was modified to allow the LVL billets to dry before testing after being subjected to the vacuum-pressure water soak test. The LVL billets were laid up using 25 plies of poplar and pine veneers, with the four pine veneers used being located as veneer layers 3, 5, 20 and 23 in a balanced assembly. Two assembly times were used to simulate assembly times in actual production. The first closed assembly time was 20 minutes, which expired after lay-up and pre-pressing but before hot pressing. The second was 48 minutes in open and closed assembly time between lay-up and hot pressing.

After curing in the hot press and hot stacking for 24 hours, the billets were cut into test strips that were 3.5 inches in thickness, two inches wide, and 15 inches long. From these test strips, 2 inch by 2 inch blocks were cut, five from each strip, and the opposite sides of each test specimen were kerfed to a 1.75 inch thickness to the center glue line, making the step blocks used in the test method. Five test specimens were taken from each test strip to produce an average of 15 shear tests per adhesive system. The center glue lines of each test specimen were subjected to a compressive shear failure, based on the force applied by the test jig in the direction of the wood veneer grain. The results were reported as an average of 15 tests.

The results show that the Present Invention Adhesive, when used to make 3.5 inch thick LVL billets, whether subjected to the dry or the vacuum-pressure water soak test, was as strong as the Control Adhesive (without added AF resin cure promoter) when bonded to the poplar veneers.

The above examples demonstrate the exceptional versatility of adhesives of the present invention in providing LVL products having good bonding characteristics, and other properties desired in the industry.

1. A method for making laminated veneer lumber (LVL) from a plurality of wood veneers, said method comprising:
(a) applying an adhesive onto a mating surface of at least one of said wood veneers, wherein said adhesive comprises:
i) a thermosetting phenol-aldehyde resin having at least one of (A) a number average molecular weight (Mₙ) of at least about 450, (B) a weight average molecular weight (M_{w}) of at least about 2000, and (C) an Z-average molecular weight (M_{z}) of at least about 6000, wherein said Mₙ, M_{w}, and M_{z} are measured using gel permeation chromatography (GPC); and
ii) a ketone-aldehyde resin cure promoter, and
(b) forming LVL from said wood veneers,
wherein at least one of said veneers has a moisture content of less than about 7% by weight or said plurality of wood veneers has an average moisture content of less than about 10% by weight.

2. The method of claim 1, wherein step (b) comprises:
(i) pre-pressing said wood veneers, having said mating surface to which said adhesive has been applied, under pre-pressing conditions to form a panel, and,
(ii) hot-pressing said panel at curing conditions to cure said adhesive.

3. The method of claim 1, wherein said plurality of wood veneers has an average moisture content from about 3% to about 7% by weight.

4. The method of claim 1, wherein said thermosetting phenol-aldehyde resin is prepared from a mixture having a phenol:aldehyde mole ratio from about 0.38:1 to about 0.53:1.

5. The method of claim 2, wherein, in step (b), said hot-pressing is conducted at least about 30 minutes after said pre-pressing.

6. The method of claim 2, wherein said pre-pressing conditions include a pressure from about 150 psig to about 175 psig.

7. The method of claim 2, wherein said curing conditions include a temperature from about 285° F. to about 345° F. and a pressure from about 190 psig to about 350 psig.

8. The method of claim 1, wherein said thermosetting phenol-aldehyde resin is a phenol-formaldehyde resin.

9. The method of claim 1, wherein said ketone-aldehyde resin cure promoter is an acetone-formaldehyde resin cure promoter.

10. The method of claim 1, wherein said applying step (a) comprises curtain coating said phenol-aldehyde resin onto said mating surface and thereafter spraying said ketone-aldehyde resin cure promoter onto said phenol-aldehyde resin.

11. The method of claim 1 wherein said ketone-aldehyde resin cure promoter is present in an amount from about 1% to about 20% by weight of the combined amount of phenol-aldehyde resin and ketone-aldehyde resin cure promoter.

12. The method of claim 1, wherein said LVL comprises at least 13 wood veneers.

13. An adhesive composition comprising:
(a) a thermosetting phenol-aldehyde resin having at least one of (A) a number average molecular weight (Mₙ) of at least about 450, (B) a weight average molecular weight (M_{w}) of at least about 2000, and (C) a Z-average molecular weight (M_{z}) of at least about 6000, wherein said Mₙ, M_{w}, and M_{z} are measured using gel permeation chromatography (GPC);
(b) a ketone-aldehyde resin cure promoter, and
(c) a soya compound having a protein level of at least about 50% by weight,
wherein said adhesive composition reaches a viscosity of 3000 centipoise at a temperature of 77° F., in a time of less than about 20 minutes after the initial mixing of (a), (b), and (c).

14. The adhesive composition of claim 13, wherein said soya compound is a soy protein concentrate having a protein level of at least about 70% by weight.

15. A method for making laminated veneer lumber (LVL) from a plurality of wood veneers, said method comprising:
(a) applying the adhesive composition of claim 13 onto a mating surface of at least one of said wood veneers, and
(b) forming LVL from said wood veneers,
wherein said LVL comprises from 13 to 29 wood veneers.

16. The method of claim 15, wherein said thermosetting phenol-aldehyde resin, said ketone-aldehyde resin cure promoter, and said soya compound are mixed continuously prior to or during said applying step (a), in proportions that depend on at least one of a measured veneer moisture level and a measured veneer temperature.

17. An adhesive composition comprising:
(a) a thermosetting phenol-aldehyde resin having at least one of (A) a number average molecular weight (Mₙ) of at least about 450, (B) a weight average molecular weight (M_{w}) of at least about 2000, and (C) a Z-average molecular weight (M_{z}) of at least about 6000, wherein said Mₙ, M_{w}, and M_{z} are measured using gel permeation chromatography (GPC); and
(b) a ketone-aldehyde resin cure promoter, and
(c) a catalyst selected from the group consisting of an acetate, a carbamate, an ester, a lactone, and a carbonate.

18. A method for making laminated veneer lumber (LVL) from a plurality of wood veneers, said method comprising:
(a) applying the adhesive composition of claim 17 onto a mating surface of at least one of said wood veneers, and
(b) forming LVL from said wood veneers,
wherein at least one of said veneers has a moisture content of greater than about 15% by weight or said plurality of wood veneers has an average moisture content of greater than about 10% by weight.

19. The method of claim 18, wherein said catalyst is triacetin that is present in an amount from about 1% to about 3% by weight of said adhesive composition.

20. The method of claim 18, wherein said thermosetting phenol-aldehyde resin, said ketone-aldehyde resin cure promoter, and said catalyst are mixed continuously prior to or during said applying step (a), in proportions that depend on at least one of a measured veneer moisture level and a measured veneer temperature.
